(19) United States
(12) Patent Application Publication
(10) Pub. No.: US 2016/0083634 A1
(43) Pub. Date: Mar. 24, 2016

(54) CURABLE COMPOSITION AND JOINT STRUCTURE PRODUCED USING SAME

(71) Applicant: SEKISUI FULLER COMPANY, LTD., Tokyo (JP)

(72) Inventor: Takuto IKEUCHI, Shiga (JP)

(73) Assignee: Sekisui Fuller Company, Ltd., Tokyo (JP)

(21) Appl. No.: 14/785,365

(22) PCT Filed: Apr. 23, 2014
(86) PCT No.: PCT/JP2014/061492

§ 371 Date: Oct. 19, 2015

(30) Foreign Application Priority Data
Apr. 24, 2013 (JP) 2013-091225
Jul. 8, 2013 (JP) 2013-143107
Sep. 20, 2013 (JP) 2013-194865

(51) Int. Cl. C09K 3/10; E04B 1/68

(52) U.S. Cl. CPC C09K 3/1018; E04B 1/6801; C09K 2003/1056; C09K 2200/0476

(57) ABSTRACT

A curable composition is characterized by containing a polyalkylene oxide (A) having a hydrolyzable silyl group, an acrylic polymer (B) having a hydrolyzable silyl group, and an alkoxysilane oligomer (C) which is a hydrolysis-condensation product obtained from an alkylalkoxysilane and an aminoalkoxysilane and contains nitrogen atoms in an amount of 1% by weight or more.

### TECHNICAL FIELD

The present invention relates to a curable composition that cures with moisture in an atmosphere and gives a cured product excellent in weather resistance and to a joint structure produced using the curable composition.

### BACKGROUND ART

A curable composition containing an oxyalkylene-based polymer having cross-linkable and hydrolyzable silyl groups has been known (for example, Patent Literature 1). This curable composition forms a cured product excellent in adhesion through hydrolysis of the cross-linkable and hydrolyzable silyl groups with moisture contained in an atmosphere followed by dehydration condensation.

Such a curable composition is used, for example, to mutually join exterior wall members such as mortar boards, concrete boards, ALC (Autoclaved Light-weight Concrete) boards, or metal boards for exterior walls of a building construction. Specifically, the exterior wall members are mutually joined by filling joint portions (so called “joints”) therebetween with the curable composition. The use of the curable composition suppresses ingress of rainwater into the building construction through the joint portions between the exterior wall members.

On the exterior walls of a building construction, the exterior wall members expand and contract with a change in temperature, and vibrations or external force caused by an earthquake or strong wind causes the exterior wall members to move, so that the joints are changed slightly in width. Therefore, it is necessary for the curable composition to exhibit excellent rubber elasticity after curing so that the cured curable composition is stretchable and can follow the change in the width of the joints.

### CITATION LIST

### Patent Literature

Patent Literature 1: Japanese Patent Application Laid-Open No. H2008-1833

### SUMMARY OF INVENTION

### Technical Problem

However, with the conventional curable composition, its rubber elasticity after curing deteriorates with time, and the cured composition becomes hard and does not easily expand and contract. Therefore, when the joints are changed in width, the cured composition cannot easily follow the change in the width of the joints. A problem in this case is as follows. Separation of exterior wall members may occur at their adhesive interfaces, and the exterior wall members may be damaged. In addition, cracks may occur in the cured product of the curable composition, and accordingly, rainwater may enter the building construction, which may lead to leakage of water.

Accordingly, an object of the present invention is to provide a curable composition that can maintain excellent rubber elasticity for a long time after curing.

### Means for Solving Problem

The curable composition of the present invention contains:

a polyalkylene oxide (A) having a hydrolyzable silyl group;

an acrylic polymer (B) having a hydrolyzable silyl group; and

an alkoxysilane oligomer (C) that is a hydrolysis-condensation product obtained from an alkylalkoxysilane and an aminoalkoxysilane, the alkoxysilane oligomer (C) containing nitrogen atoms in an amount of 1% by weight or more.

### [Polyalkylene Oxide (A)]

The polyalkylene oxide (A) contained in the curable composition has a hydrolyzable silyl group. The hydrolyzable silyl group is a group including 1 to 3 hydrolyzable groups bonded to a silicon atom.

No particular limitation is imposed on the hydrolyzable groups in the hydrolyzable silyl group, and examples thereof include a hydrogen atom, a halogen atom, an alkoxy group, an acyloxy group, a ketoximate group, an amino group, an amido group, an acid amido group, an aminooxy group, a mercapto group, and an alkenyloxy group.

Particularly, an alkoxysilyl group is preferred as the hydrolyzable silyl group because of its mild hydrolysis reaction. Examples of the alkoxysilyl group include: trialkoxysilyl groups such as a trimethoxysilyl group, a triethoxysilyl group, a triisopropoxysilyl group, and a triphenoxysilyl group; dimethoxysilyl groups such as a dimethoxymethylsilyl group and a diethoxymethylsilyl group; and monoalkoxysilyl groups such as a methoxydimethoxysilyl group and an ethoxydimethylsilyl group. Of these, dialkoxysilyl groups are more preferred, and a dimethoxymethylsilyl group is particularly preferred.

Preferably, the polyalkylene oxide (A) has 1 to 2 hydrolyzable silyl groups per molecule on average. One or more hydrolyzable silyl groups in the polyalkylene oxide (A) improve the curability of the curable composition. Two or less hydrolyzable silyl groups in the polyalkylene oxide (A) improve the mechanical strength or extensibility of the cured product of the curable composition. Preferably, the polyalkylene oxide (A) has a hydrolyzable silyl group at at least one of the both ends of its main chain.

The average number of hydrolyzable silyl groups per molecule in the polyalkylene oxide (A) can be computed on the basis of the concentration of the hydrolyzable silyl groups in the polyalkylene oxide (A) that is determined by ¹H-NMR and the number average molecular weight of the polyalkylene oxide (A) that is determined by GPC.

Preferred examples of the polyalkylene oxide-based polymer (A) include a polymer having a main chain including a repeating unit represented by a general formula: —(R—O)ₙ— (wherein R represents an alkylene group having 1 to 14 carbon atoms, and n is the number of repeating units and is a positive integer). The main chain backbone of the polyalkylene oxide-based polymer may be composed of only one type of repeating unit or two or more types of repeating units.

Examples of the main chain backbone of the polyalkylene oxide-based polymer (A) include polyethylene oxides, polypropylene oxides, polybutylene oxides, polytetramethylene oxides, polyethylene oxide-polypropylene oxide copolymers, and polypropylene oxide-polybutylene oxide copolymers. Of these, polypropylene oxides are preferred. The use of a polypropylene oxide can provide a curable composition excellent in rubber elasticity and adhesion after curing.

The number average molecular weight of the polyalkylene oxide-based polymer (A) is preferably 10,000 to 50,000 and more preferably 15,000 to 30,000. The number average molecular weight of the polyalkylene oxide-based polymer (A) of 10,000 or more improves the mechanical strength or extensibility of the cured product of the curable composition. The number average molecular weight of the polyalkylene oxide-based polymer (A) of 50,000 or less improves the applicability of the curable composition.

In the present invention, the number average molecular weight of the polyalkylene oxide-based polymer (A) means a value in terms of polystyrene measured by GPC (gel permeation chromatography). In the measurement by GPC, Shodex KF800D manufactured by TOSOH Corporation, for example, can be used as a GPC column, and chloroform etc. can be used as a solvent.

A commercial product can be used as the polyalkylene oxide-based polymer (A) including a hydrolyzable silyl group. Examples of the polyalkylene oxide-based polymer in which its main chain backbone is polypropylene oxide and which has a dimethoxymethylsilyl group at each end of the main chain backbone include “Excestar 52410 (product name)” manufactured by Asahi Glass Co., Ltd. and “S203 (product name)” manufactured by Kaneka Corporation.

### [Acrylic Polymer (B)]

The acrylic polymer (B) contained in the curable composition has a hydrolyzable silyl group.

The hydrolyzable silyl group is preferably an alkoxysilyl group because the cured product of the curable composition can maintain excellent rubber elasticity for a long time. Examples of the alkoxysilyl group include: trialkoxysilyl groups such as a trimethoxysilyl group, a triethoxysilyl group, a triisopropoxysilyl group, and a triphenoxysilyl group; dialkoxysilyl groups such as a dimethoxymethylsilyl group and a diethoxymethylsilyl group; and monoalkoxysilyl groups such as a methoxydimethoxysilyl group and an ethoxydimethylsilyl group. Of these, dialkoxysilyl groups are more preferred, and a dimethoxymethylsilyl group is particularly preferred.

Preferably, the acrylic polymer (B) has 1 to 2 hydrolyzable silyl groups per molecule on average. More preferably, the acrylic polymer (B) has 1 to 1.8 hydrolyzable silyl groups per molecule on average. One or more hydrolyzable silyl groups in the acrylic polymer (B) improve the curability of the curable composition. Two or less hydrolyzable silyl groups in the acrylic polymer (B) improve the mechanical strength or extensibility of the cured product of the curable composition. Preferably, the acrylic polymer (B) has a hydrolyzable silyl group at at least one of the both ends of its main chain. More preferably, the acrylic polymer (B) has a hydrolyzable silyl group at each of the both ends of the main chain.

The average number of hydrolyzable silyl groups per molecule in the acrylic polymer (B) can be computed on the basis of the concentration of hydrolyzable silyl groups in the acrylic polymer (B) that is determined by ¹H-NMR and the number average molecular weight of the acrylic polymer (B) that is determined by GPC.

Examples of the main chain backbone of the acrylic polymer (B) include acrylic polymers obtained by radical polymerization of (meth)acrylate monomers such as ethyl(meth)acrylate and butyl(meth)acrylate. The (meth)acrylate means methacrylate or acrylate.

Specific examples of the (meth)acrylate monomer constituting the main chain of the acrylic polymer (B) include methyl(meth)acrylate, ethyl(meth)acrylate, propyl(meth)acrylate, n-butyl(meth)acrylate, tert-butyl(meth)acrylate, cyclohexyl(meth)acrylate, 2-ethylhexyl(meth)acrylate, n-octyl(meth)acrylate, isooctyl(meth)acrylate, isononyl(meth)acrylate, isomyristyl(meth)acrylate, stearyl(meth)acrylate, isobornyl(meth)acrylate, benzyl(meth)acrylate, 2-butoxyethyl(meth)acrylate, 2-phenoxyethyl(meth)acrylate, glycidyl(meth)acrylate, tetrahydrofurfuryl(meth)acrylate, hexanediol di(meth)acrylate, ethylene glycol di(meth)acrylate, propylene glycol di(meth)acrylate, neopentyl glycol di(meth)acrylate, trimethylolpropane tri(meth)acrylate, pentaerythritol di(meth)acrylate, pentaerythritol tri(meth)acrylate, pentaerythritol tetra(meth)acrylate, dipentaerythritol hexa(meth)acrylate, epoxy(meth)acrylate, polyester(meth)acrylate, urethane(meth)acrylate, 2-hydroxyethyl(meth)acrylate, 3-hydroxypropyl(meth)acrylate, 2-hydroxypropyl(meth)acrylate, 4-hydroxybutyl(meth)acrylate, 2-hydroxybutyl(meth)acrylate, 5-hydroxypentyl(meth)acrylate, 6-hydroxyhexyl(meth)acrylate, 3-hydroxy-3-methylbutyl(meth)acrylate, 2-hydroxy-3-phenoxypropyl(meth)acrylate, 2-[acryloyloxy]ethyl-2-hydroxyethyl phthalic acid, and 2-[acryloyloxy]ethyl-2-hydroxypropyl phthalic acid. One type of these (meth)acrylate monomers may be used alone, or a combination of two or more types may be used.

The acrylic polymer (B) may be copolymerized with other monomers. Examples of such a monomer include: styrene and styrene derivatives such as indene, α-methylstyrene, p-methylstyrene, p-chlorostyrene, p-chloromethylstyrene, p-methoxystyrene, p-tert-butoxystyrene, and divinylbenzene; compounds having a vinyl ester group such as vinyl acetate, vinyl propionate, vinyl butyrate, vinyl caproate, vinyl benzoate, and vinyl cinnamate; maleic anhydride; N-vinylpyrrolidone; N-vinylmorpholine; (meth)acrylonitrile; (meth)acrylamide; N-cyclohexylmaleimide; N-phenylmaleimide; N-laurylmaleimide; N-benzylmaleimide; and compounds having a vinyloxy group such as n-propyl vinyl ether, n-butyl vinyl ether, isobutyl vinyl ether, tert-butyl vinyl ether, tert-amyl vinyl ether, cyclohexyl vinyl ether, 2-ethylhexyl vinyl ether, dodecyl vinyl ether, octadecyl vinyl ether, 2-chloroethyl vinyl ether, ethylene glycol butyl vinyl ether, triethylene glycol methyl vinyl ether, (4-vinyloxy)butyl benzoate, ethylene glycol divinyl ether, diethylene glycol divinyl ether, triethylene glycol divinyl ether, tetraethylene glycol divinyl ether, butane-1,4-diol-divinyl ether, hexane-1,6-diol-divinyl ether, cyclohexane-1,4-dimethanol-divinyl ether, di(4-vinyloxy)butyl isophthalate, di(4-vinyloxy)butyl glutarate, di(4-vinyloxy)butyl succinate trimethylolpropane trivinyl ether, 2-hydroxyethyl vinyl ether, 4-hydroxybutyl vinyl ether, 6-hydroxyhexyl vinyl ether, cyclohexane-1,4-dimethanol monovinyl ether, diethylene glycol monovinyl ether, 3-aminopropyl vinyl ether, 2-(N,N-diethylamino)ethyl vinyl ether, urethane vinyl ether, and polyester vinyl ether. One type of these monomers may be used alone, or a combination of two or more types may be used.

The main chain backbone of the acrylic polymer (B) is preferably a copolymer of butyl(meth)acrylate and methyl(meth)acrylate and more preferably a copolymer of butyl acrylate and methyl methacrylate. With the acrylic polymer (B) with the main chain backbone composed of any of the above copolymers, a curable composition that can form a cured product having both extensibility and flexibility after curing can be obtained.

No particular limitation is imposed on the polymerization method for the acrylic polymer (B), and any known method can be used. Examples of the polymerization method include various polymerization methods such as a free radical polymerization method, an anionic polymerization method, a cationic polymerization method, a UV radical polymerization method, a living anionic polymerization method, a living cationic polymerization method, and a living radical polymerization method.

No particular limitation is imposed on the method of introducing the hydrolyzable silyl groups into the acrylic polymer (B), and any known method may be used. For example, a hydrosilane having a hydrolyzable silyl group is reacted with an acrylic polymer including an unsaturated group introduced into its molecule to thereby hydrosilylate the acrylic polymer (B).

The number average molecular weight of the acrylic polymer (B) is preferably 12,000 to 50,000 and more preferably 15,000 to 30,000. The number average molecular weight of the acrylic polymer (B) of 50,000 or less improves the applicability of the curable composition. The number average molecular weight of the acrylic polymer (B) of 12,000 or more improves the mechanical strength or extensibility of the cured product of the curable composition.

In the present invention, the number average molecular weight of the acrylic polymer means a value in terms of polystyrene measured by GPC (gel permeation chromatography). In the measurement by GPC, Shodex KF800D manufactured by TOSOH Corporation, for example, can be used as a GPC column, and chloroform etc. can be used as a solvent.

The amount of the acrylic polymer (B) contained in the curable composition is preferably 30 to 200 parts by weight with respect to 100 parts by weight of the polyalkylene oxide-based polymer (A) and more preferably 50 to 150 parts by weight. The amount of the acrylic polymer (B) of 30 parts by weight or more in the curable composition allows the cured product of the curable composition to maintain excellent rubber elasticity for a long time. The amount of the acrylic polymer (B) of 200 parts by weight or less in the curable composition improves the applicability of the curable composition.

[Alkoxysilane oligomer (C)]

The curable composition contains the alkoxysilane oligomer (C), which is a hydrolysis-condensation product obtained from an alkylalkoxysilane and an aminoalkoxysilane. Specifically, the curable composition contains the alkoxysilane oligomer (C) that is obtained by hydrolyzing the alkylalkoxysilane and the aminoalkoxysilane and then condensing the hydrolysis products.

The alkylalkoxysilane means a compound in which at least one alkyl group and at least two alkoxy groups are directly bonded to a silicon atom. The alkylalkoxysilane is preferably a monoalkyltrialkoxysilane in which one alkyl group and three alkoxy groups are directly bonded to a silicon atom. Specific examples of the alkylalkoxysilane include methyltrimethoxysilane, methyltriethoxysilane, ethyltrimethoxysilane, ethyltriethoxysilane, and hexyltrimethoxysilane. Of these, ethyltriethoxysilane is preferred.

The aminoalkoxysilane means a compound which has at least one amino group-containing functional group in its molecule and in which at least two alkoxy groups are directly bonded to a silicon atom. Preferably, the amino group-containing functional group is directly bonded to the silicon atom. Preferably, the aminoalkoxysilane is a compound which has one amino group-containing functional group in its molecule and in which three alkoxy groups are directly bonded to a silicon atom.

The amino group-containing functional group is preferably an aminopropyl functional group because it facilitates curing of the curable composition, further improves the adhesion of the curable composition, and allows the cured product of the curable composition to maintain excellent rubber elasticity for a long time. Preferably, the aminopropyl functional group is at least one aminopropyl functional group selected from the group consisting of —(CH₂)₃—NH₂, —(CH₂)₃—NHR, —(CH₂)₃—NH(CH₂)₂—NH₂ (a 3-[N-(2-aminoethyl)amino]propyl group), and —(CH₂)₃—NH(CH₂)₂—NH(CH₂)₂—NH₂ (a 3-[[2-(2-aminoethylamino)ethyl]amino]propyl group). The aminopropyl functional group is more preferably —(CH₂)₃—NH(CH₂)₂—NH₂ because it is excellent in adhesion to various base materials and allows the cured product of the curable composition to maintain excellent rubber elasticity for a long time.

In —(CH₂)₃—NHR, R is an alkyl group having 1 to 18 carbon atoms, a monovalent saturated alicyclic hydrocarbon group having 3 to 18 carbon atoms, or an aryl group having 6 to 12 carbon atoms.

Examples of the alkyl group having 1 to 18 carbon atoms include linear alkyl groups and branched alkyl groups. Examples of the linear alkyl groups include a methyl group, an ethyl group, a propyl group, an n-butyl group, an n-pentyl group, an n-hexyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, and an n-octadecyl group. Preferably, the linear alkyl group is a methyl group, an ethyl group, or an n-butyl group. Examples of the branched alkyl groups include an isopropyl group, an isobutyl group, a sec-butyl group, and a tert-butyl group.

Examples of the saturated alicyclic hydrocarbon group having 3 to 18 carbon atoms include a cyclopentyl group, a cycloheptyl group, a cyclohexyl group, a 4-methylcyclohexyl group, and a cyclooctyl group. Of these, a cyclohexyl group is preferred.

Examples of the aryl group having 6 to 12 carbon atoms include a phenyl group, a benzyl group, a tolyl group, and an o-xylyl group. Of there, a phenyl group is preferred.

Specific examples of the aminoalkoxysilane include 3-aminopropyltrimethoxysilane, 3-aminopropyltriethoxysilane, N-methyl-aminopropyltrimethoxysilane, N-methyl-aminopropyltriethoxysilane, N-n-butyl-aminopropyltrimethoxysilane, N-n-butyl-aminopropyltriethoxysilane, N-cyclohexylaminopropyltrimethoxysilane, N-cyclohexylaminopropyltriethoxysilane, N-phenyl-aminopropyltrimethoxysilane, N-phenyl-aminopropyltriethoxysilane, 3-[N-(2-aminoethyl)amino]propyltrimethoxysilane, 3-[N-(2-aminoethyl)amino]propyltriethoxysilane, [3-[2-(2-aminoethylamino)ethylamino]propyl]trimethoxysilane, [3-[2-(2-aminoethylamino)ethylamino]propyl]triethoxysilane, 3-aminopropylmethyldimethoxysilane, 3-aminopropylmethyldiethoxysilane, N-methyl-aminopropylmethyldimethoxysilane, N-methyl-aminopropylmethyldiethoxysilane, N-n-butyl-aminopropylmethyldimethoxysilane, N-n-butyl-aminopropylmethyldiethoxysilane, N-cyclohexylaminopropylmethyldimethoxysilane, N-cyclohexylaminopropylmethyldiethoxysilane, N-phenyl-aminopropylmethyldimethoxysilane, N-phenyl-aminopropylmethyldiethoxysilane, 3-[N-(2-aminoethyl)amino]propylmethyldimethoxysilane, 3-[N-(2-aminoethyl)amino]propylmethyldiethoxysilane, [3-[2-(2-aminoethylamino)ethylamino]propyl]methyldimethoxysilane, and [3-[2-(2-aminoethylamino)ethylamino]propyl]methyldiethoxysilane. The aminoalkoxysilane is preferably 3-[N-(2-aminoethyl)amino]propyltrimethoxysilane or 3-[N-(2-aminoethyl)amino]propyltriethoxysilane and more preferably 3-[N-(2-aminoethyl)amino]propyltriethoxysilane.

Preferably, the alkoxysilane oligomer (C) is a hydrolysis-condensation product obtained from a monoalkyltrialkoxysilane and an aminoalkoxysilane in which one aminopropyl functional group and three alkoxy groups are directly bonded to a silicon atom.

Preferably, the alkoxysilane oligomer (C) is a hydrolysis-condensation product obtained from a monoalkyltrialkoxysilane and a 3-[N-(2-aminoethyl)amino]propyltrialkoxysilane.

Preferably, the alkoxysilane oligomer (C) is a hydrolysis-condensation product obtained from a monoalkyltriethoxysilane and a 3-[N-(2-aminoethyl)amino]propyltrialkoxysilane.

Particularly preferably, the alkoxysilane oligomer (C) is a hydrolysis-condensation product obtained from a monoalkyltrialkoxysilane and 3-[N-(2-aminoethyl)amino]propyltriethoxysilane.

Particularly preferably, the alkoxysilane oligomer (C) is a hydrolysis-condensation product obtained from ethyltriethoxysilane and 3-[N-(2-aminoethyl)amino]propyltriethoxysilane.

The alkoxysilane oligomer (C) is obtained by hydrolyzing the alkoxy groups included in the alkylalkoxysilane and the alkoxy groups included in the aminoalkoxysilane to form silanol groups and then condensing these silanol groups. The silanol group means a hydroxy group directly bonded to a silicon atom (Si—OH).

The alkoxysilane oligomer (C) used may be a commercial product. Examples of the commercial product include an alkoxysilane oligomer manufactured by Evonik Degussa Japan Co., Ltd. under the product name “Dynasylan 1146.”

The alkoxysilane oligomer (C) has a viscosity of preferably 100 mPa·s or less, more preferably 50 mPa·s or less, and particularly preferably 30 mPa·s or less. The viscosity of the alkoxysilane oligomer (C) being 100 mPa·s or less preferably causes the alkoxysilane oligomer (C) to move to a bonding interface, which may cause the curable composition to exert sufficient adhesion.

The viscosity of the alkoxysilane oligomer (C) is a value measured using a B-type viscometer under the conditions of 20° C. and a number of revolutions of 60 rpm according to JIS Z8803.

The alkoxysilane oligomer (C) has a weight average molecular weight of preferably 500 to 1,000, more preferably 550 to 900, and particularly preferably 600 to 850. The weight average molecular weight of the alkoxysilane oligomer (C) being 500 or more preferably imparts excellent rubber elasticity to the cured product of the curable composition. The weight average molecular weight of the alkoxysilane oligomer (C) being 1,000 or less preferably causes the alkoxysilane oligomer (C) to move to a bonding interface and thereby improves the adhesion of the curable composition.

In the present invention, the weight average molecular weight of the alkoxysilane oligomer (C) means a value in terms of polystyrene measured by GPC (gel permeation chromatography). In the measurement by GPC, Shodex KF800D manufactured by TOSOH Corporation, for example, can be used as a GPC column, and tetrahydrofuran etc. can be used as a solvent.

The amount of the alkoxysilane oligomer (C) contained in the curable composition is preferably 1 to 10 parts by weight with respect to 100 parts by weight of the polyalkylene oxide-based polymer (A) and more preferably 1.5 to 5 parts by weight. The amount of the alkoxysilane oligomer (C) of 1 part by weight or more in the curable composition improves the adhesion of the curable composition. The amount of the alkoxysilane oligomer (C) of 10 parts by weight or less in the curable composition allows the cured product of the curable composition to maintain excellent rubber elasticity for a long time.

The amount of nitrogen atoms contained in the alkoxysilane oligomer (C) is 1% by weight or more, preferably 3 to 10% by weight, more preferably 5 to 10% by weight, particularly preferably 5 to 8% by weight, and most preferably 5 to 7% by weight. The alkoxysilane oligomer (C) in which the amount of nitrogen atoms falls within the above range can further improve the moisture-resistant adhesion of the curable composition. Such a curable composition can form a cured product that can maintain excellent rubber elasticity for a long time. The amount of nitrogen atoms contained in the alkoxysilane oligomer (C) can be controlled by means of an alkoxysilane containing a nitrogen atom in its molecule such as an aminoalkoxysilane.

The amount of nitrogen atoms contained in the alkoxysilane oligomer (C) is a value measured using a CHN elemental analyzer. For example, the amount of nitrogen atoms can be determined under the following measurement conditions.

Apparatus: CHN elemental analyzer (vario EL III manufactured by Elementar)

Amount of sample: 10 mg

Temperature of combustion tube: 950° C.

Temperature of reduction tube: 500° C.

Carrier gas: 200 mL/min

Detector: TCD

Reference sample: Acetanilide (reference sample for elemental analysis) C=71.09%, H=6.710%, N=10.36%)

Quantification method: Multipoint calibration curve method using reference sample

### [Plasticizer]

The curable composition may further contain a plasticizer. Specific examples of the plasticizer include: phthalates such as dioctyl phthalate, dibutyl phthalate, and butyl benzyl phthalate; polyalkylene oxides such as polypropylene glycol; and acrylic polymers. Of these, acrylic polymers are preferred. The acrylic polymers include at least an acrylic polymer containing no hydrolyzable silyl group. To prevent a reduction in rubber elasticity with time, an acrylic polymer containing a hydrolyzable silyl group may be used. Preferably, the acrylic polymer contains 0.1 to 0.5 hydrolyzable silyl groups per molecule on average. When the average number of hydrolyzable silyl groups in one acrylic polymer molecule is 0.1 or more, the plasticizer is kept between the main chains of the acrylic polymer (B), so that bleedout of the plasticizer is suppressed. Therefore, the cured product of the curable composition has excellent rubber elasticity for a long time. When the average number of hydrolyzable silyl groups in one acrylic polymer molecule is 0.5 or less, the cross-linking density due to the acrylic polymer (B) and the plasticizer does not become excessively high. Therefore, the curable composition is plasticized, and the cured product of the curable composition has excellent rubber elasticity. The acrylic polymer has a weight average molecular weight of preferably 500 to 10,000 and more preferably 1,000 to 5,000. The weight average molecular weight of the acrylic polymer of 500 or more can inhibit bleedout of the plasticizer out of the acrylic polymer (B). The weight average molecular weight of the acrylic polymer of 10,000 or less allows the curable composition to be sufficiently plasticized. In this case, the cured product of the curable composition has excellent rubber elasticity.

The amount of the plasticizer contained in the curable composition is preferably 100 parts by weight or less with respect to 100 parts by weight of the total of the polyalkylene oxide-based polymer (A) and the acrylic polymer (B), more preferably 70 parts by weight or less, and particularly preferably 1 to 70 parts by weight. An excessively large amount of the plasticizer in the curable composition may cause bleeding of the plasticizer.

### [Filler]

Preferably, the curable composition further contains a filler. The filler allows a curable composition that can form a cured product excellent in mechanical strength to be provided.

Examples of the filler include calcium carbonate, magnesium carbonate, calcium oxide, hydrous silicic acid, silicic acid anhydride, fine silica powder, calcium silicate, titanium dioxide, clay, talc, carbon black, and glass balloons. One type of these fillers may be used alone, or a combination of two or more types may be used. Particularly, calcium carbonate is preferably used.

The average particle diameter of calcium carbonate is preferably 0.01 to 5 μm and more preferably 0.05 to 2.5 μm. The use of calcium carbonate having such an average particle diameter allows a curable composition that can form a cured product excellent in mechanical strength and extensibility and has excellent adhesion to be provided.

Preferably, the calcium carbonate is surface-treated with a fatty acid or a fatty acid ester. The use of the calcium carbonate surface-treated with a fatty acid or a fatty acid ester can impart thixotropy to the curable composition, and suppress aggregation of the calcium carbonate.

The amount of the filler contained in the curable composition is preferably 1 to 700 parts by weight with respect to 100 parts by weight of the total of the polyalkylene oxide-based polymer (A) and the acrylic polymer (B) and more preferably 10 to 200 parts by weight. The amount of the filler of 1 part by weight or more in the curable composition allows the effect due to addition of the filler to be obtained sufficiently. The amount of the filler of 700 parts by weight or less in the curable composition allows a cured product obtained by curing the curable composition to have excellent extensibility.

### [Dehydrating Agent]

Preferably, the curable composition further contains a dehydrating agent. With the dehydrating agent, curing of the curable composition with moisture contained in air during storage of the curable composition can be suppressed.

Examples of the dehydrating agent include: silane compounds such as vinyltrimethoxysilane, dimethyldimethoxysilane, tetraethoxysilane, methyltrimethoxysilane, methyltriethoxysilane, tetramethoxysilane, phenyltrimethoxysilane, and diphenyldimethoxysilane; and ester compounds such as methyl orthoformate, ethyl orthoformate, methyl orthoacetate, and ethyl orthoacetate. One type of these dehydrating agents may be used alone, or a combination of two or more types may be used. Particularly, vinyltrimethoxysilane is preferred.

The amount of the dehydrating agent contained in the curable composition is preferably 0.5 to 20 parts by weight with respect to 100 parts by weight of the total of the polyalkylene oxide-based polymer (A) and the acrylic polymer (B) and more preferably 1 to 15 parts by weight. The amount of the dehydrating agent of 0.5 parts by weight or more in the curable composition allows the effect due to the dehydrating agent to be sufficiently obtained. The amount of the dehydrating agent of 20 parts by weight or less in the curable composition allows the curable composition to have excellent curability.

### [Silanol Condensation Catalyst]

Preferably, the curable composition contains a silanol condensation catalyst. The silanol condensation catalyst is a catalyst for facilitating the dehydration condensation reaction of silanol groups formed by hydrolysis of the hydrolyzable silyl groups contained in the polyalkylene oxide-based polymer (A), the hydrolyzable silyl groups included in the acrylic polymer (B), the alkoxysilyl groups contained in the alkoxysilane oligomer (C), etc.

Examples of the silanol condensation catalyst include: organotin-based compounds such as 1,1,3,3-tetrabutyl-1,3-dilauryloxycarbonyl-distannoxane, dibutyltin dilaurate, dibutyltin oxide, dibutyltin diacetate, dibutyltin phthalate, bis(dibutyltin laurate)oxide, dibutyltin bis(acetylacetonate), dibutyltin bis(monoestermalate), tin octylate, dibutyltin octoate, dioctyltin oxide, dibutyltin bis(triethoxysilicate), bis(dibutyltin bistriethoxysilicate)oxide, and dibutyltin oxybisethoxysilicate; and organic titanium-based compounds such as tetra-n-butoxytitanate and tetra-isopropoxy titanate. One type of these silanol condensation catalysts may be used alone, or a combination of two or more types may be used.

Preferably, the silanol condensation catalyst is 1,1,3,3-tetrabutyl-1,3-dilauryloxycarbonyl-distannoxane. With such a silanol condensation catalyst, the curing rate of the curable composition can be easily controlled.

The amount of the silanol condensation catalyst contained in the curable composition is preferably 1 to 10 parts by weight with respect to 100 parts by weight of the total of the polyalkylene oxide-based polymer (A) and the acrylic polymer (B) and more preferably 1 to 5 parts by weight. The amount of the silanol condensation catalyst of 1 part by weight or more in the curable composition increases the curing rate of the curable composition, so that the time required to cure the curable composition can be reduced. The amount of the silanol condensation catalyst of 10 parts by weight or less in the curable composition allows the curable composition to have an appropriate curing rate and allows the storage stability and handleability of the curable composition to be improved.

### [Other Additives]

The curable composition may further contain other additives such as a thixotropy imparting agent, an antioxidant, an ultraviolet absorber, a pigment, a dye, an anti-settling additive, and a solvent. Of these, a thixotropy imparting agent, an ultraviolet absorber, and an antioxidant are preferred.

Any thixotropy imparting agent can be used so long as it can impart thixotropy to the curable composition. Preferred examples of the thixotropy imparting agent include hydrogenated castor oil, fatty acid bisamides, and fumed silica.

The amount of the thixotropy imparting agent contained in the curable composition is preferably 0.1 to 200 parts by weight with respect to 100 parts by weight of the total of the polyalkylene oxide-based polymer (A) and the acrylic polymer (B) and more preferably 1 to 150 parts by weight. The amount of the thixotropy imparting agent of 0.1 parts by weight or more in the curable composition allows thixotropy to be effectively imparted to the curable composition. The amount of the thixotropy imparting agent of 200 parts by weight or less in the curable composition allows the curable composition to have an appropriate viscosity and improves the handleability of the curable composition.

Examples of the ultraviolet absorber include benzotriazole-based ultraviolet absorbers and benzophenone-based ultraviolet absorbers. Of these, benzotriazole-based ultraviolet absorbers are preferred. The amount of the ultraviolet absorber contained in the curable composition is preferably 0.1 to 20 parts by weight with respect to 100 parts by weight of the total of the polyalkylene oxide-based polymer (A) and the acrylic polymer (B) and more preferably 0.1 to 10 parts by weight.

Examples of the antioxidant include hindered phenol-based antioxidants, monophenol-based antioxidants, bisphenol-based antioxidants, and polyphenol-based antioxidants. Of these, hindered phenol-based antioxidants are preferred. The amount of the antioxidant contained in the curable composition is preferably 0.1 to 20 parts by weight with respect to 100 parts by weight of the total of the polyalkylene oxide-based polymer (A) and the acrylic polymer (B) and more preferably 0.3 to 10 parts by weight.

### [Light Stabilizer]

Preferably, the curable composition contains a hindered amine-based light stabilizer. The hindered amine-based light stabilizer allows a curable composition that can maintain excellent rubber elasticity for a longer time after curing to be provided.

Examples of the hindered amine-based light stabilizer include: a mixture of bis(1,2,2,6,6-pentamethyl-4-piperidyl)sebacate and methyl 1,2,2,6,6-pentamethyl-4-piperidylsebacate; bis(2,2,6,6-tetramethyl-4-piperidyl)sebacate; a polycondensation product of dibutylamine.1,3,5-triazine.N,N′-bis(2,2,6,6-tetramethyl-4-piperidyl-1,6-hexamethylenediamine and N-(2,2,6,6-tetramethyl-4-piperidyl)butylamine; poly[{6-(1,1,3,3-tetramethylbutyl)amino-1,3,5-triazine-2,4-diyl}{(2,2,6,6-tetramethyl-4-piperidyl)imino}hexamethylene {(2,2,6,6-tetramethyl-4-piperidyl)imino}]; and a polycondensation product of dimethyl succinate and 4-hydroxy-2,2,6,6-tetramethyl-1-piperidineethanol.

Preferred examples of the hindered amine-based light stabilizer include an NOR-type hindered amine-based light stabilizer. The NOR-type hindered amine-based light stabilizer can provide a curable composition in which a reduction in rubber elasticity with time after curing is restrained.

The NOR-type hindered amine-based light stabilizer has an NOR structure in which an alkyl group (R) is bonded to a nitrogen atom (N) contained in a piperidine ring skeleton by the intermediary of an oxygen atom (0). The number of carbon atoms in the alkyl group in the NOR structure is preferably 1 to 20, more preferably 1 to 18, and particularly preferably 18. Examples of the alkyl group include linear alkyl groups, branched alkyl groups, and cyclic alkyl groups (saturated alicyclic hydrocarbon groups).

Examples of the linear alkyl groups include a methyl group, an ethyl group, an n-propyl group, an n-butyl group, an n-pentyl group, an n-hexyl group, an n-octyl group, an n-nonyl group, and an n-decyl group. Examples of the branched alkyl groups include isopropyl, isobutyl, sec-butyl, and tert-butyl. Examples of the cyclic alkyl groups (saturated alicyclic hydrocarbon groups) include a cyclopentyl group, a cyclohexyl group, and a cyclooctyl group. A hydrogen atom constituting the alkyl group may be substituted with a halogen atom (such as a fluorine atom, a chlorine atom, or a bromine atom) or a hydroxyl group, etc.

Examples of the NOR-type hindered amine-based light stabilizer include a hindered amine-based light stabilizer represented by the formula (I) below.

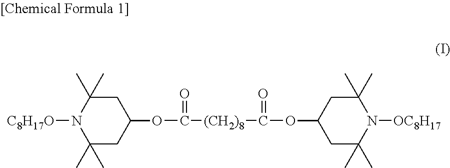

When the NOR-type hindered amine-based light stabilizer is used, it is preferable to use a combination of the NOR-type hindered amine-based light stabilizer and a benzotriazole-based ultraviolet absorber or a triazine-based ultraviolet absorber. This allows a curable composition in which a reduction in rubber elasticity with time after curing is highly restrained to be provided.

The amount of the hindered amine-based light stabilizer contained in the curable composition is preferably 0.01 to 20 parts by weight with respect to 100 parts by weight of the total of the polyalkylene oxide-based polymer (A) and the acrylic polymer (B) and more preferably 0.1 to 10 parts by weight.

The curable composition can form a cured product that is excellent in adhesion and can maintain excellent rubber elasticity for a long time and therefore can be used for various applications such as sealing materials, coating materials, adhesives, and paints. Particularly, the curable composition is used preferably as a sealing material and more preferably as a sealing material for a joint structure.

One method used to obtain a joint structure by applying the curable composition to joints is a method including filling the joints with the curable composition, then aging the curable composition, and curing the curable composition. The joint structure obtained includes wall members constituting a wall portion of a building construction and the cured product of the curable composition with which joints formed between adjacent wall members are filled. Examples of the wall portion of the building construction include an exterior wall, an interior wall, and a ceiling. Examples of the wall members include exterior wall members, interior wall members, and ceiling members.

No particular limitation is imposed on the joints. Examples of the joints include joints in exterior walls, interior walls, and ceilings of building constructions. The curable composition of the present invention can maintain excellent rubber elasticity for a long time after curing. The cured product can therefore have a high ability to follow a change in the width of joints that is caused by expansion and contraction of the members due to a change in their temperature according to atmospheric temperature, solar irradiation, etc. or caused by the action of vibrations or wind pressure, so that damage to the members and water leakage into the building construction can be prevented. Therefore, the curable composition can be preferably used to seal joints that undergo a large change in width such as joints in exterior walls of building constructions. These joints are also referred to as “working joints.”

Examples of the joints in exterior walls of building constructions include joints formed in junction portions between exterior wall members such as mortar boards, concrete boards, ceramic-based siding boards, metal-based siding boards, ALC boards, and metal boards.

### Advantageous Effects of Invention

The curable composition of the present invention contains the polyalkylene oxide (A) including a hydrolyzable silyl group, the acrylic polymer (B) including a hydrolyzable silyl group, and the alkoxysilane oligomer (C) obtained by hydrolysis and condensation of an alkylalkoxysilane and an aminoalkoxysilane. Therefore, the curable composition can form a cured product that is excellent in adhesion and can maintain excellent rubber elasticity for a long time.

### DESCRIPTION OF EMBODIMENTS

The present invention will next be described more specifically by way of Examples. However, the present invention is not limited to the Examples.

### Examples

### Synthesis Example 1

### Acrylic Polymer (B1)

100 g of n-butyl acrylate (manufactured by Nippon Shokubai Co., Ltd.), 0.6 g of 3-methacryloxypropylmethyldimethoxysilane (product name “KBM-502,” manufactured by Shin-Etsu Chemical Co., Ltd.), 0.9 g of 3-mercaptopropylmethyldimethoxysilane (chain transfer agent, product name “KBM-802,” manufactured by Shin-Etsu Chemical Co., Ltd.), and 100 g of ethyl acetate were supplied to a 0.5 L separable flask equipped with a stirrer, a condenser, a thermometer, and a nitrogen gas inlet and were then mixed to produce a monomer mixture solution.

Nitrogen gas was bubbled into the monomer mixture solution for 20 minutes to thereby remove dissolved oxygen in the monomer mixture solution. Next, air in the separable flask was replaced with nitrogen gas, and then the temperature of the monomer mixture solution was increased under stirring until circulation occurred.

0.024 g of 1,1-di(t-hexylperoxy)-3,3,5-trimethylcyclohexane was dissolved in 1 g of ethyl acetate to produce a first polymerization initiator solution. The first polymerization initiator solution was supplied to the monomer mixture solution.

0.036 g of 1,1-di(t-hexylperoxy)-3,3,5-trimethylcyclohexane was dissolved in 1 g of ethyl acetate to produce a second polymerization initiator solution. One hour after the first polymerization initiator solution was supplied to the monomer mixture solution, the second polymerization initiator solution was supplied to the resultant monomer mixture solution.

0.048 g of di(3,5,5-trimethylhexanoyl)peroxide was dissolved in 1 g of ethyl acetate to produce a third polymerization initiator solution. Two hours after the second polymerization initiator solution was supplied to the monomer mixture solution, the third polymerization initiator solution was supplied to the resultant monomer mixture solution.

0.12 g of di(3,5,5-trimethylhexanoyl)peroxide was dissolved in 1 g of ethyl acetate to produce a fourth polymerization initiator solution. Three hours after the second polymerization initiator solution was supplied to the monomer mixture solution, the fourth polymerization initiator solution was supplied to the resultant monomer mixture solution.

0.36 g of di(3,5,5-trimethylhexanoyl)peroxide was dissolved in 1 g of ethyl acetate to produce a fifth polymerization initiator solution. Four hours after the second polymerization initiator solution was supplied to the monomer mixture solution, the fifth polymerization initiator solution was supplied to the resultant monomer mixture solution.

Seven hours after the first polymerization initiator solution was supplied to the monomer mixture solution, the reaction solution was cooled to room temperature to complete polymerization. An ethyl acetate solution containing an acrylic polymer (B1) having dimethoxymethylsilyl groups was thereby obtained.

Next, ethyl acetate was removed using an evaporator to obtain the acrylic polymer (B1). The acrylic polymer (B1) obtained had 1.47 dimethoxymethylsilyl groups per molecule on average and had a number average molecular weight of 20,000.

### Synthesis Example 2

### Acrylic Polymer (B4)

100 g of n-butyl acrylate (manufactured by Nippon Shokubai Co., Ltd.), 0.9 g of 3-methacryloxypropylmethyldimethoxysilane (product name “KBM-502,” manufactured by Shin-Etsu Chemical Co., Ltd.), 0.9 g of 3-mercaptopropylmethyldimethoxysilane (chain transfer agent, product name “KBM-802,” manufactured by Shin-Etsu Chemical Co., Ltd.), and 100 g of ethyl acetate were supplied to a 0.5 L separable flask equipped with a stirrer, a condenser, a thermometer, and a nitrogen gas inlet and were then mixed to prepare a monomer mixture solution.

Polymerization was performed in the same manner as in Synthesis Example 1 except that the above monomer mixture solution was used. An ethyl acetate solution containing an acrylic polymer (B4) having dimethoxymethylsilyl groups was thereby obtained.

Next, ethyl acetate was removed using an evaporator to obtain the acrylic polymer (B4). The acrylic polymer (B4) obtained had 1.85 dimethoxymethylsilyl groups per molecule on average and had a number average molecular weight of 20,000.

### Synthesis Example 3

### Acrylic Polymer (B5)

100 g of n-butyl acrylate (manufactured by Nippon Shokubai Co., Ltd.), 0.6 g of 3-methacryloxypropylmethyltrimethoxysilane (product name “KBM-503,” manufactured by Shin-Etsu Chemical Co., Ltd.), 0.9 g of 3-mercaptopropylmethyltrimethoxysilane (chain transfer agent, product name “KBM-803,” manufactured by Shin-Etsu Chemical Co., Ltd.), and 100 g of ethyl acetate were supplied to a 0.5 L separable flask equipped with a stirrer, a condenser, a thermometer, and a nitrogen gas inlet and were then mixed to prepare a monomer mixture solution.

Polymerization was performed in the same manner as in Synthesis Example 1 except that the above monomer mixture solution was used. An ethyl acetate solution containing an acrylic polymer (B4) having dimethoxymethylsilyl groups was thereby obtained.

Next, ethyl acetate was removed using an evaporator to obtain the acrylic polymer (B5). The acrylic polymer (B5) obtained had 1.45 trimethoxysilyl groups per molecule on average and had a number average molecular weight of 20,000.

### Examples 1 to 9 and Comparative Examples 1 to 6

The following components were mixed until uniform in a sealed stirrer under reduced pressure with a blending amount shown in TABLEs 1 and 2 to thereby obtain a curable composition:

polyalkylene oxide (A) (product name “Excestar S2410,” manufactured by Asahi Glass Co., Ltd.) including dimethoxymethylsilyl groups and having a main chain backbone composed of polypropylene oxide;

acrylic polymer (B1) having dimethoxymethylsilyl groups (average number of dimethoxymethylsilyl groups per molecule: 1.47, number average molecular weight: 20,000);

acrylic polymer (B2) having a dimethoxymethylsilyl group at each of both ends of its main chain (product name “SA420S,” manufactured by Kaneka Corporation, average number of dimethoxymethylsilyl groups per molecule: 1.7, number average molecular weight: 22,000, monomer components of the main chain: n-butyl acrylate, ethyl acrylate, and n-octadecyl acrylate);

acrylic polymer (B3) having a dimethoxymethylsilyl group at each of both ends of its main chain (product name “SA310S,” manufactured by Kaneka Corporation, average number of dimethoxymethylsilyl groups per molecule: 1.7, number average molecular weight: 28,000, monomer components of the main chain: n-butyl acrylate and n-octadecyl acrylate);

acrylic polymer (B4) having dimethoxymethylsilyl groups and obtained in Synthesis Example 2 above (average number of dimethoxymethylsilyl groups per molecule: 1.85, number average molecular weight: 20,000);

acrylic polymer (B5) having trimethoxysilyl groups and obtained in Synthesis Example 3 above (average number of trimethoxysilyl groups per molecule: 1.45, number average molecular weight: 20,000);

alkoxysilane oligomer (C1) (hydrolysis-condensation product obtained from ethyltriethoxysilane and 3-[N-(2-aminoethyl)amino]propyltriethoxysilane, product name “Dynasylan 1146,” manufactured by Evonik Degussa Japan Co., Ltd., content of nitrogen atoms: 6% by weight, viscosity (20° C.): 20 mPa·s);

alkoxysilane oligomer (C2) (hydrolysis-condensation product obtained from an alkylalkoxysilane and an aminoalkoxysilane, product name “X-40-2651,” manufactured by Shin-Etsu Chemical Co., Ltd., content of nitrogen atoms: 0.7% by weight, viscosity (20° C.): 20 mPa·s);

an aminosilane coupling agent (N-2-(aminoethyl)-3-aminopropyltrimethoxysilane, product name “KBM-603,” manufactured by Shin-Etsu Chemical Co., Ltd.);

plasticizer (1) (acrylic polymer containing no hydrolyzable silyl groups, product name “UP1110,” manufactured by TOAGOSEI Co., Ltd., weight average molecular weight: 2,000);

plasticizer (2) (acrylic polymer containing 0.2 hydrolyzable silyl groups per molecule on average, product name “US6100,” manufactured by Toagosei Co., Ltd., weight average molecular weight: 2,400);

plasticizer (3) (acrylic polymer containing 0.7 hydrolyzable silyl groups per molecule on average, product name “US6400,” manufactured by Toagosei Co., Ltd., weight average molecular weight: 2,800);

colloidal calcium carbonate (product name “PLS-505,” manufactured by Konoshima Chemical Co., Ltd.);

heavy calcium carbonate (product name “NCC2310,” manufactured by Nitto Funka Kogyo K.K.)

a dehydrating agent (vinyltrimethoxysilane, product name “KBM-1003,” manufactured by Shin-Etsu Chemical Co., Ltd.);

a silanol condensation catalyst (1,1,3,3-tetrabutyl-1,3-dilauryloxycarbonyl-distannoxane, product name “NEOSTANN U-130” manufactured by Nitto Kasei Co., Ltd.);

a benzotriazole-based ultraviolet absorber (product name “TINUVIN 326,” manufactured by BASF Japan Ltd.);

a hindered phenol-based antioxidant (product name “IRGANOX 1010,” manufactured by BASF Japan Ltd.);

an NH-type hindered amine-based light stabilizer (product name “TINUVIN 770,” manufactured by BASF Japan Ltd.); and

an NOR-type hindered amine-based light stabilizer represented by formula (I) above (product name “TINUVIN 123,” manufactured by BASF Japan Ltd.).

### (Evaluation)

One of the curable compositions was used to produce an H-type specimen according to JIS A1439 4.21. Specifically, two aluminum plates (50 mm length×50 mm width×3 mm thickness) subjected to alumite treatment were used to sandwich a spacer therebetween to thereby form a cuboidal space (12 mm length×50 mm width×12 mm thickness) in a central portion between the aluminum plates. The space was filled with the curable composition such that no air entered the space. After the space was filled with the curable composition, the curable composition was left to stand in an atmosphere of a temperature of 23° C. and a relative humidity of 50% for 14 days. Then the curable composition was further left to stand in an atmosphere of a temperature of 30° C. for 14 days. By aging and curing the curable composition, an H-type specimen in which the two aluminum plates were adhesively integrated by the intermediary of the cured product of the curable composition was produced.

Then the H-type specimen immediately after production was subjected to a tensile test at a tensile speed of 50 mm/minutes in an atmosphere of a temperature of 23° C. and a relative humidity of 50% according to JIS A1439 to measure a 50% modulus [N/cm²] and an elongation [%] at maximum load. The results obtained are shown in “INITIAL” rows in TABLE 1.

Next, the H-type specimen was left to stand in an atmosphere of a temperature of 90° C. for 70 days. After the H-type specimen was left to stand, its 50% modulus [N/cm²] and its elongation [%] at maximum load were measured in the same manner as described above. The results obtained are shown in “90° C., AFTER 70 DAYS” rows in TABLE 1.

The curable composition in Comparative Example 1 could not be evaluated because two aluminum plates could not be adhesively integrated by the intermediary of the cured product of the curable composition and an H-type specimen could not be produced.

TABLE 1

| | | | EXAM- | EXAM- | EXAM- | EXAM- | EXAM- | EXAM- | EXAM- | EXAM- | EXAM- |
|---|---|---|---|---|---|---|---|---|---|---|---|
| | | | PLE 1 | PLE 2 | PLE 3 | PLE 4 | PLE 5 | PLE 6 | PLE 7 | PLE 8 | PLE 9 |
| COMPOSITION | POLYALKYLENE OXIDE (A) | | 100 | 100 | 100 | 100 | 100 | 100 | 100 | 100 | 100 |
| [PARTS BY | (METH)ACRYLIC POLYMER (B1) | | 100 | 0 | 0 | 0 | 0 | 0 | 0 | 0 | 0 |
| WEIGHT] | (METH)ACRYLIC POLYMER (B2) | | 0 | 100 | 0 | 100 | 100 | 100 | 100 | 0 | 0 |
| | (METH)ACRYLIC POLYMER (B3) | | 0 | 0 | 100 | 0 | 0 | 0 | 0 | 0 | 0 |
| | (METH)ACRYLIC POLYMER (B4) | | 0 | 0 | 0 | 0 | 0 | 0 | 0 | 100 | 0 |
| | (METH)ACRYLIC POLYMER (B5) | | 0 | 0 | 0 | 0 | 0 | 0 | 0 | 0 | 100 |
| | ALKOXYSILANE OLIGOMER (C1) | | 4 | 4 | 4 | 4 | 4 | 4 | 4 | 4 | 4 |
| | ALKOXYSILANE OLIGOMER (C2) | | 0 | 0 | 0 | 0 | 0 | 0 | 0 | 0 | 0 |
| | AMINOSILANE COUPLING AGENT | | 0 | 0 | 0 | 0 | 0 | 0 | 0 | 0 | 0 |
| | PLASTICIZER (1) | | 120 | 0 | 120 | 120 | 0 | 0 | 120 | 120 | 120 |
| | PLASTICIZER (2) | | 0 | 120 | 0 | 0 | 120 | 0 | 0 | 0 | 0 |
| | PLASTICIZER (3) | | 0 | 0 | 0 | 0 | 0 | 120 | 0 | 0 | 0 |
| | COLLOIDAL CALCIUM CARBONATE | | 200 | 200 | 200 | 200 | 200 | 200 | 200 | 200 | 200 |
| | HEAVY CALCIUM CARBONATE | | 100 | 100 | 100 | 100 | 100 | 100 | 100 | 100 | 100 |
| | DEHYDRATING AGENT | | 6 | 6 | 6 | 6 | 6 | 6 | 6 | 6 | 6 |
| | SILANOL CONDENSATION CATALYST | | 4 | 4 | 4 | 4 | 4 | 4 | 4 | 4 | 4 |
| | BENZOTRIAZOLE-BASED | | 4 | 4 | 4 | 4 | 4 | 4 | 4 | 4 | 4 |
| | ULTRAVIOLET ABSORBER | | | | | | | | | | |
| | HINDERED PHENOL-BASED | | 2 | 2 | 2 | 2 | 2 | 2 | 2 | 2 | 2 |
| | ANTIOXIDANT | | | | | | | | | | |
| | NH-TYPE HINDERED AMINE- | | 4 | 4 | 4 | 0 | 0 | 4 | 4 | 4 | 4 |
| | BASED LIGHT STABILIZER | | | | | | | | | | |
| | NOR-TYPE HINDERED AMINE- | | 0 | 0 | 0 | 4 | 4 | 0 | 0 | 0 | 0 |
| | BASED LIGHT STABILIZER | | | | | | | | | | |
| EVALUATION | (INITIAL) | 50% MODULUS[N/cm²] | 9.6 | 9.4 | 9.0 | 9.1 | 9.2 | 13.1 | 9.1 | 13.4 | 12.7 |
| | | ELONGATION AT | 570 | 610 | 600 | 600 | 610 | 580 | 600 | 530 | 550 |
| | | MAXIMUM LOAD[%] | | | | | | | | | |
| | (90° C., | 50% MODULUS[N/cm²] | 15.2 | 12.4 | 15.7 | 14.5 | 12.1 | 18.4 | 14.7 | 18.5 | 16.4 |
| | AFTER | | | | | | | | | | |
| | 70 DAYS) | ELONGATION AT | 450 | 490 | 530 | 550 | 560 | 430 | 460 | 410 | 420 |
| | | MAXIMUM LOAD[%] | | | | | | | | | |

TABLE 2

| | | | COMPAR- | COMPAR- | COMPAR- | COMPAR- | COMPAR- | COMPAR- |
|---|---|---|---|---|---|---|---|---|
| | | | ATIVE | ATIVE | ATIVE | ATIVE | ATIVE | ATIVE |
| | | | EXAM- | EXAM- | EXAM- | EXAM- | EXAM- | EXAM- |
| | | | PLE 1 | PLE 2 | PLE 3 | PLE 4 | PLE 5 | PLE 6 |
| COMPOSITION | POLYALKYLENE OXIDE (A) | | 100 | 200 | 100 | 100 | 200 | 100 |
| [PARTS BY | (METH)ACRYLIC POLYMER (B1) | | 0 | 0 | 0 | 0 | 0 | 0 |
| WEIGHT] | (METH)ACRYLIC POLYMER (B2) | | 100 | 0 | 100 | 100 | 0 | 100 |
| | (METH)ACRYLIC POLYMER (B3) | | 0 | 0 | 0 | 0 | 0 | 0 |
| | (METH)ACRYLIC POLYMER (B4) | | 0 | 0 | 0 | 0 | 0 | 0 |
| | (METH)ACRYLIC POLYMER (B5) | | 0 | 0 | 0 | 0 | 0 | 0 |
| | ALKOXYSILANE OLIGOMER (C1) | | 0 | 4 | 0 | 0 | 0 | 0 |
| | ALKOXYSILANE OLIGOMER (C2) | | 0 | 0 | 0 | 0 | 0 | 4 |
| | AMINOSILANE COUPLING AGENT | | 0 | 0 | 4 | 4 | 4 | 0 |
| | PLASTICIZER (1) | | 120 | 120 | 120 | 0 | 120 | 120 |
| | PLASTICIZER (2) | | 0 | 0 | 0 | 120 | 0 | 0 |
| | PLASTICIZER (3) | | 0 | 0 | 0 | 0 | 0 | 0 |
| | COLLOIDAL CALCIUM CARBONATE | | 200 | 200 | 200 | 200 | 200 | 200 |
| | HEAVY CALCIUM CARBONATE | | 100 | 100 | 100 | 100 | 100 | 100 |
| | DEHYDRATING AGENT | | 6 | 6 | 6 | 6 | 6 | 6 |
| | SILANOL CONDENSATION CATALYST | | 4 | 4 | 4 | 4 | 4 | 4 |
| | BENZOTRIAZOLE-BASED | | 4 | 4 | 4 | 4 | 4 | 4 |
| | ULTRAVIOLET ABSORBER | | | | | | | |
| | HINDERED PHENOL-BASED | | 2 | 2 | 2 | 2 | 2 | 2 |
| | ANTIOXIDANT | | | | | | | |
| | NH-TYPE HINDERED AMINE-BASED | | 4 | 4 | 4 | 4 | 4 | 4 |
| | LIGHT STABILIZER | | | | | | | |
| | NOR-TYPE HINDERED AMINE-BASED | | 0 | 0 | 0 | 0 | 0 | 0 |
| | LIGHT STABILIZER | | | | | | | |
| EVALUATION | (INITIAL) | 50% MODULUS[N/cm²] | — | 12.3 | 9.3 | 9.2 | 10.0 | 9.3 |
| | | ELONGATION AT | — | 600 | 580 | 580 | 590 | 580 |
| | | MAXIMUM LOAD[%] | | | | | | |
| | (90° C., | 50% MODULUS[N/cm²] | — | 21.4 | 21.9 | 22.0 | 24.1 | 19.6 |
| | AFTER | ELONGATION AT | — | 380 | 350 | 380 | 300 | 300 |
| | 70 DAYS) | MAXIMUM LOAD[%] | | | | | | |

### INDUSTRIAL APPLICABILITY

The curable composition of the present invention maintains excellent rubber elasticity for a long time after curing. Therefore, the curable composition can be preferably used as, for example, a filler for junction portions formed between exterior wall members forming an exterior wall of a building construction.

1. A curable composition comprising:
a polyalkylene oxide (A) having a hydrolyzable silyl group;
an acrylic polymer (B) having a hydrolyzable silyl group; and
an alkoxysilane oligomer (C) that is a hydrolysis-condensation product obtained from an alkylalkoxysilane and an aminoalkoxysilane, the alkoxysilane oligomer (C) containing nitrogen atoms in an amount of 1% by weight or more.

2. The curable composition according to claim 1, wherein the alkoxysilane oligomer (C) has at least one aminopropyl functional group selected from the group consisting of —(CH₂)₃—NH₂, —(CH₂)₃—NHR, —(CH₂)₃—NH(CH₂)₂—NH₂, and —(CH₂)₃—NH(CH₂)₂—NH(CH₂)₂—NH₂ (in the formula, R is an alkyl group having 1 to 18 carbon atoms, a monovalent saturated alicyclic hydrocarbon group having 3 to 18 carbon atoms, or an aryl group having 6 to 12 carbon atoms).

3. The curable composition according to claim 1, wherein the alkoxysilane oligomer (C) has an aminopropyl functional group represented by a formula of —(CH₂)₃—NH(CH₂)₂—NH₂.

4. The curable composition according to claim 1, wherein the acrylic polymer (B) has 1 to 2 hydrolyzable silyl groups per molecule on average.

5. The curable composition according to claim 1, wherein the acrylic polymer (B) has a hydrolyzable silyl group at at least one of both ends of a main chain thereof.

6. The curable composition according to claim 1, comprising an NOR-type hindered amine-based light stabilizer.

7. A joint structure comprising:
wall members constituting a wall portion of a building construction; and
a cured product of the curable composition according to claim 1 with which a joint formed between the wall members is filled.
